(19) United States
(12) Patent Application Publication
(10) Pub. No.: US 2026/0204827 A1
(43) Pub. Date: Jul. 16, 2026

(54) CONNECTOR

(71) Applicant: Yazaki Corporation, Tokyo (JP)

(72) Inventors: Motohide Sato, Makinohara-shi (JP); Narumi Suzuki, Makinohara-shi (JP)

(21) Appl. No.: 19/444,803

(22) Filed: Jan. 9, 2026

(30) Foreign Application Priority Data
Jan. 14, 2025 (JP) 2025-004546

(51) Int. Cl. H01R 13/424; H01R 13/10; H01R 13/502

(52) U.S. Cl. CPC H01R 13/424; H01R 13/10; H01R 13/502; H01R 2201/26

(57) ABSTRACT

Provided is a connector including: a connector housing (2) including a cylindrical fitting portion (7) opening and protruding in a tubular shape in a direction of being fitted to a mating connector; an inner housing (4) including terminal holding members (12) fitted into the cylindrical fitting portion (7) in a state of being accommodated inside the connector housing (2); a connector terminal (5) held by the terminal holding members (12); and a wire cord (6) having one end joined to the connector terminal (5) and the other end extended outside of the connector housing (2) through a hole portion (8a) in the connector housing (2). The connector housing (2) includes a guide portion (19) that regulates positions of the terminal holding members (12) with respect to the cylindrical fitting portion (7) in a one direction in which the terminal holding members (12) are fitted into the cylindrical fitting portion (7).

### BACKGROUND OF THE INVENTION

### Field of the Invention

Aspects of the present disclosure relate to a connector. Priority is claimed on Japanese Patent Application No. 2025-004546 filed in Japan on January 14, 2025, the content of which is incorporated herein by reference.

### Description of Related Art

Conventionally, as an electronic device mounted on a vehicle, for example, a device connector attached to a housing of a device such as an inverter or a motor mounted on a hybrid vehicle or an electric vehicle is known (for example, see Patent Document 1).

Specifically, Patent Document 1 discloses a connector to be fitted to a counterpart device. A connector disclosed in Patent Document 1 includes a pair of terminal portions that face a counterpart device, and a housing body made of a synthetic resin that accommodates the pair of terminal portions. Each of the terminal portions includes a device-side terminal fitted to the counterpart device, a cable-side terminal connected to a cable, and a connection conductor connecting the device-side terminal and the cable-side terminal and having flexibility. The connection conductor is provided with an extra length portion and extends toward the device-side terminal. The housing body includes a housing portion that accommodates the pair of terminal portions, and an insulating wall disposed within the housing portion to insulate the connection conductors from each other.

### Prior Art Document

### Patent Document

Patent Document 1: Japanese Unexamined Patent Application, First Publication No. 2024-041451

### SUMMARY OF THE INVENTION

Meanwhile, the connector described in Patent Document 1 described above is configured such that, in order to reliably insulate between the pair of terminal portions, the insulating wall is assembled so as to be inserted between the pair of terminal portions. In addition, the pair of terminal portions has a structure movable by the flexible connection conductor in order to absorb tolerance with a fitting counterpart.

However, in the connector described in Patent Document 1, a gap between the components is small, and therefore the components easily come into contact with each other, and the terminal portion may be short-circuited in some cases. In addition, a small gap between the components may hinder smooth assembly and may lead to breakage of the components in some cases.

An aspect of the present disclosure provides a connector capable of improving efficiency of assembly work while preventing occurrence of a short circuit.

A connector according to an aspect of the present disclosure includes: a connector housing including a cylindrical fitting portion opening and protruding in a tubular shape in a direction in which the cylindrical fitting portion is fitted to a mating connector; an inner housing including a plurality of terminal holding members fitted into the cylindrical fitting portion in a state of being accommodated inside the connector housing; a connector terminal held by the terminal holding members; and a wire cord having one end side joined to the connector terminal, and the other end side extended outside of the connector housing through a hole portion provided in the connector housing. The connector housing includes a guide portion that regulates positions of the terminal holding members with respect to the cylindrical fitting portion in a one direction in which the terminal holding members are fitted into the cylindrical fitting portion.

The connector according to the aspect of the present disclosure is capable of improving efficiency of assembly work while preventing occurrence of a short circuit.

### BRIEF DESCRIPTION OF THE DRAWINGS

FIG. 1 is a perspective view illustrating a constitution of a connector according to an embodiment of the present disclosure;

FIG. 2 is an exploded perspective view illustrating the constitution of the connector illustrated in FIG. 1;

FIG. 3 is a perspective view illustrating a state in which a connector cover of the connector illustrated in FIG. 1 is removed;

FIG. 4 is a plan view illustrating a state in which the connector cover of the connector illustrated in FIG. 1 is removed;

FIG. 5 is a perspective view illustrating a connector housing of the connector illustrated in FIG. 1;

FIG. 6 is a perspective view illustrating a state in the middle of fitting an inner housing into a cylindrical fitting portion of the connector housing illustrated in FIG. 5;

FIG. 7 is a cross-sectional view of the connector taken along line A-A illustrated in FIG. 4, illustrating a state in the middle of fitting the inner housing into the cylindrical fitting portion of the connector housing; and

FIG. 8 is a cross-sectional view of the connector taken along line A-A illustrated in FIG. 4, illustrating a state in which the inner housing is fitted into the cylindrical fitting portion of the connector housing.

### DETAILED DESCRIPTION OF THE INVENTION

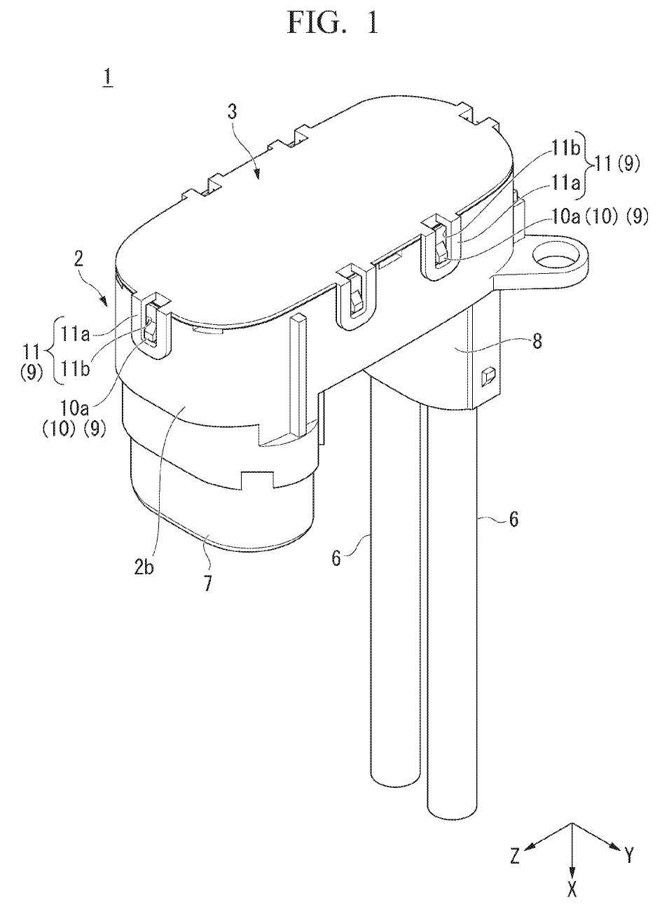

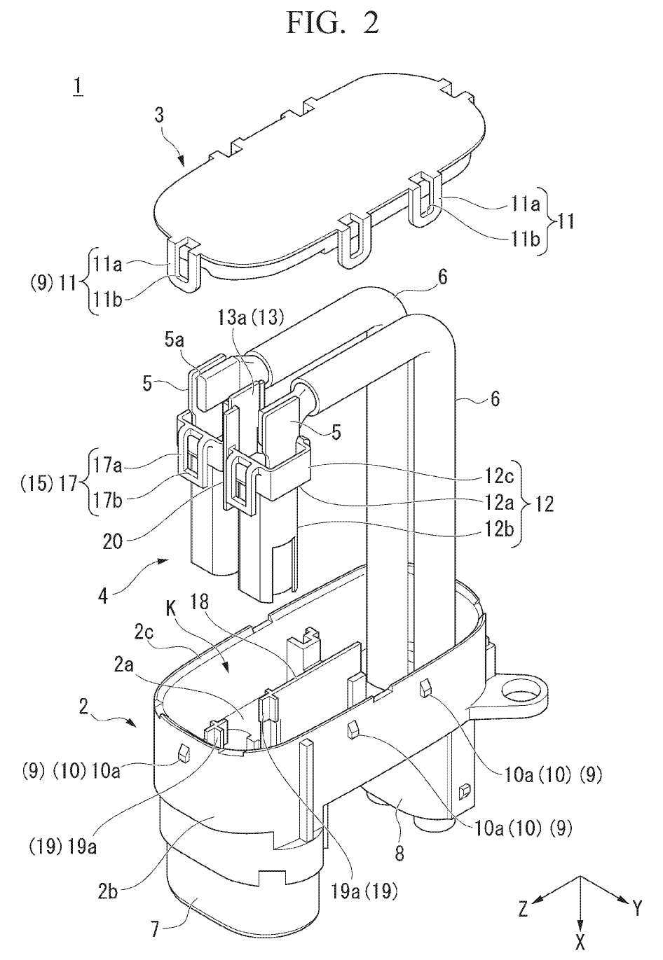

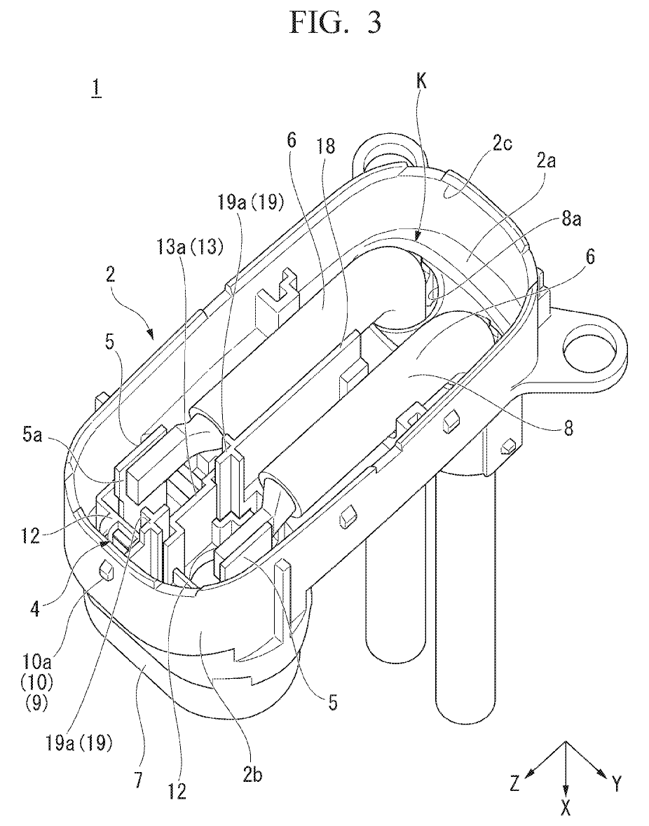

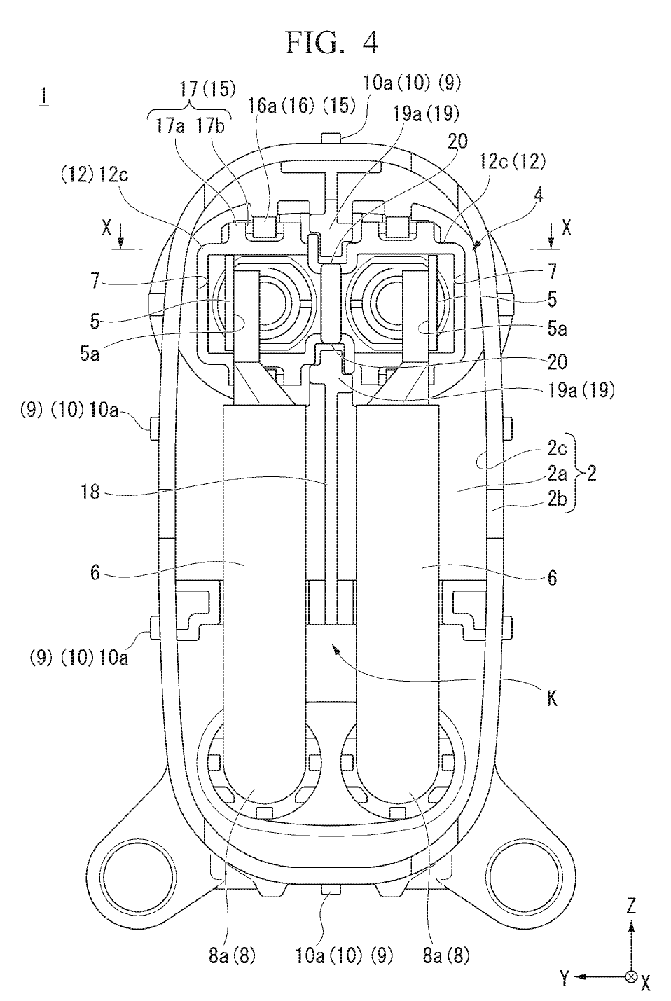

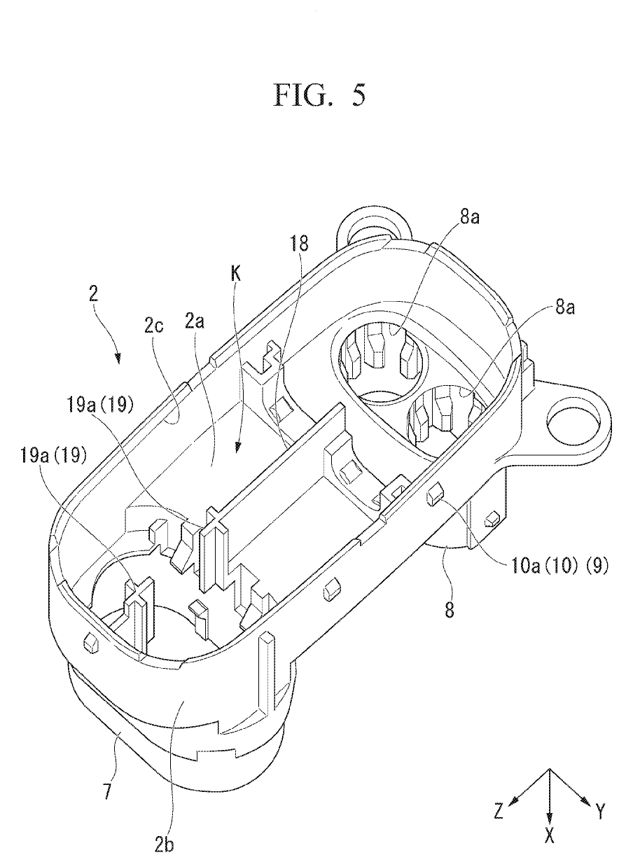

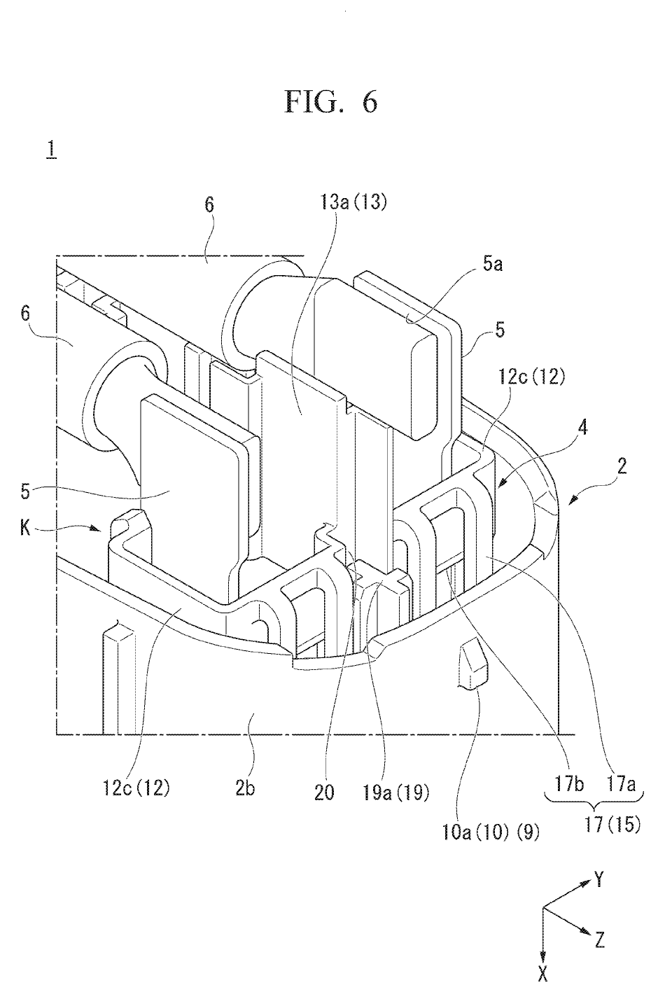

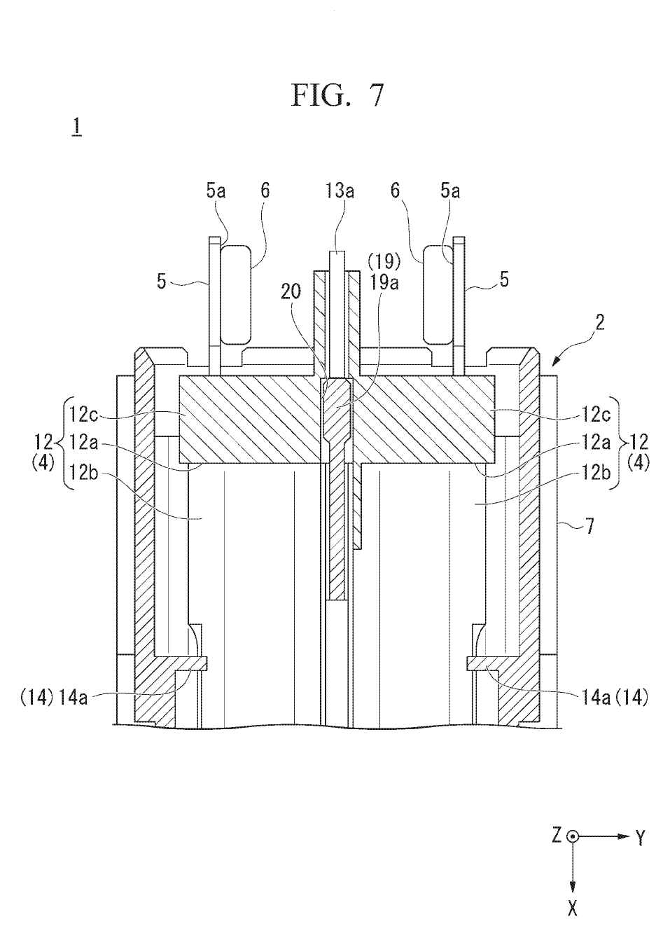

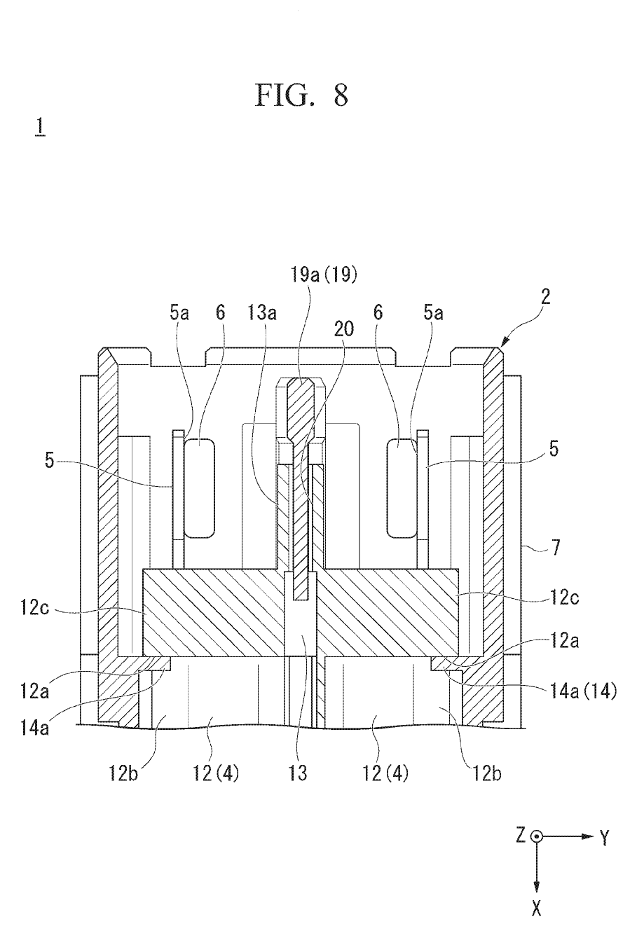

As an embodiment of the present disclosure, for example, a connector 1 illustrated in FIGS. 1 to 8 will be described. FIG. 1 is a perspective view illustrating a constitution of the connector 1. FIG. 2 is an exploded perspective view illustrating the constitution of the connector 1. FIG. 3 is a perspective view illustrating a state in which a connector cover 3 of the connector 1 is removed. FIG. 4 is a plan view illustrating a state in which the connector cover 3 of the connector 1 is removed. FIG. 5 is a perspective view illustrating a connector housing 2 of the connector 1. FIG. 6 is a perspective view illustrating a state in the middle of fitting an inner housing 4 into a cylindrical fitting portion of the connector housing 2. FIG. 7 is a cross-sectional view of the connector 1 taken along line A-A illustrated in FIG. 4, illustrating a state in the middle of fitting the inner housing 4 into the cylindrical fitting portion 7 of the connector housing 2. FIG. 8 is a cross-sectional view illustrating a state in which the inner housing 4 is fitted into the cylindrical fitting portion 7 of the connector housing 2 in a cross section of the connector 1 taken along line A-A illustrated in FIG. 4.

In addition, in the following drawings, an XYZ orthogonal coordinate system is set, and an X-axis direction is indicated as a front-rear direction of the connector 1, a Y-axis direction is indicated as a left-right direction of the connector 1, and a Z-axis direction is indicated as an up-down direction of the connector 1.

As illustrated in FIG. 1, the connector 1 of the present embodiment is fitted to a mating connector (not shown) to be electrically connected to each other. By electrically connecting the connectors to each other, electricity can be conducted between the connectors.

The connector 1 of the present embodiment constitutes a female (receptacle)-side connector. On the other hand, the mating connector constitutes a male (plug)-side connector. Note that the connector 1 of the present embodiment may constitute a male (plug)-side connector, and the mating connector may constitute a female (receptacle)-side connector.

In the present embodiment, a description will be given assuming that a one direction in which the connector 1 is fitted to the mating connector is a forward side (+X direction) of the connector 1, a direction opposite to the one direction is a rearward side (-X direction), a side facing the mating connector is a front side of the connector 1, and a side opposite thereto is a back side of the connector 1.

As illustrated in FIGS. 1 to 4, the connector 1 of the present embodiment includes the connector housing 2, the connector cover 3, the inner housing 4, a plurality (two in the present embodiment) of connector terminals 5, and a plurality (two in the present embodiment) of wire cords 6.

As illustrated in FIGS. 1 to 5, the connector housing 2 is made of a molded body of a synthetic resin. The connector housing 2 is provided in a substantially rectangular box shape as a whole and has a substantially oval shape in which four corners are rounded in a front view. Note that the connector housing 2 is not necessarily limited to such a shape, and its shape, size, and the like can be appropriately changed.

The connector housing 2 has a substantially oval front wall 2a constituting a front side thereof, a peripheral wall 2b provided so as to rise from a periphery of the front wall 2a toward a back side thereof, and a substantially oval opening 2c opened on the back side of the peripheral wall 2b.

The connector housing 2 further includes the cylindrical fitting portion 7 protruding forward from one side in the longitudinal direction of the front wall 2a and a cord lead-out portion 8 protruding forward from the other side in the longitudinal direction of the front wall 2a.

The cylindrical fitting portion 7 is a portion to be fitted with the mating connector described above. The cylindrical fitting portion 7 is opened in a substantially elongated cylindrical shape and protrudes from the front side of the front wall 2a. The longitudinal direction of the cylindrical fitting portion 7 coincides with the lateral direction of the front wall 2a.

The cord lead-out portion 8 is a portion that pulls out the wire cords 6 to be described later toward outside of the connector housing 2. The cord lead-out portion 8 protrudes from the front side of the front wall 2a and has a plurality (two in the present embodiment) of hole portions 8a therein. In the present embodiment, the two hole portions 8a are located on both sides of the front wall 2a in the lateral direction and are provided so as to penetrate the cord lead-out portion 8 in the front-rear direction in parallel to each other.

As illustrated in FIGS. 1 and 2, the connector cover 3 is made of a molded body of a synthetic resin. The connector cover 3 is provided in a substantially oval flat plate shape corresponding to the opening 2c of the connector housing 2. The connector cover 3 is attached to the back side of the connector housing 2 in a state where the opening 2c of the connector housing 2 is closed.

In addition, the connector 1 of the present embodiment has a structure that seals a space K provided between the connector housing 2 and the connector cover 3 using a waterproof rubber seal (not shown).

As illustrated in FIGS. 1 and 2, a first attaching and detaching mechanism 9 for attaching the connector cover 3 to the connector housing 2 is provided between the connector housing 2 and the connector cover 3.

The first attaching and detaching mechanism 9 includes a first locking portion 10 provided on a side one of the connector housing 2 and the connector cover 3 (the side of the connector housing 2 in the present embodiment), and a first locked portion 11 provided on the other side (the side of the connector cover 3 in the present embodiment).

In the present embodiment, the first locking portion 10 includes a plurality of locking claws 10a protruding from an outer peripheral surface of the peripheral wall 2b. The plurality of locking claws 10a are provided side by side at predetermined intervals along the outer peripheral surface of the peripheral wall 2b. In the present embodiment, a total of six locking claws 10a are arranged; two on the outer peripheral surfaces on both sides along the longitudinal direction of the peripheral wall 2b and one on the outer peripheral surfaces on both sides along the lateral direction of the peripheral wall 2b.

On the other hand, the first locked portion 11 includes a plurality of locking holes 11b provided in each of a plurality of hook pieces 11a protruding forward from an end edge of the connector cover 3. The plurality of hook pieces 11a and the plurality of locking holes 11b are provided side by side at predetermined intervals at the end edge of the connector cover 3 corresponding to the plurality of locking claws 10a, respectively. In the present embodiment, a total of six hook pieces 11a and six locking holes 11b are arranged; two at both end edges along the longitudinal direction of the connector cover 3 and one at both end edges along the lateral direction of the connector cover 3.

In the first attaching and detaching mechanism 9, each of the locking claws 10a is locked to each of the locking holes 11b of the hook pieces 11a in a state where the connector cover 3 closes the opening 2c of the connector housing 2. With this constitution, the connector 1 of the present embodiment allows attachment of the connector cover 3 to the back side of the connector housing 2 via the first attaching and detaching mechanism 9.

The above first attaching and detaching mechanism 9 is not necessarily limited to the constitution in which, described above, the locking claws 10a are locked to the locking holes 11b of the hook pieces 11a. That is, the first attaching and detaching mechanism 9 only needs to have a constitution in which the first locking portion 10 is locked to the first locked portion 11, and the first locking portion 10 and the first locked portion 11 may have a constitution different from the above constitution. In addition, the arrangement and the number of the first locking portions 10 and the first locked portions 11 can also be appropriately changed.

In addition, the above first attaching and detaching mechanism 9 is not necessarily limited to the constitution, described above, in which the first locking portion 10 provided on the side of the connector housing 2 is locked to the first locked portion 11 provided on the side of the connector cover 3. That is, the first attaching and detaching mechanism 9 can be configured to lock the first locking portion 10 provided on the side of the connector cover 3 to the first locked portion 11 provided on the side of the connector housing 2.

As illustrated in FIGS. 2 to 4 and 6, the inner housing 4 is made of a molded body of a synthetic resin. The inner housing 4 includes a plurality (two in the present embodiment) of terminal holding members 12 fitted into the cylindrical fitting portion 7 and a coupling portion 13 that couples the terminal holding members 12 adjacent to each other, in a state of being accommodated in the space K inside the connector housing 2.

The terminal holding member 12 is a portion that holds the connector terminal 5 described later. In the present embodiment, the two terminal holding members 12 are located on both sides in the longitudinal direction of the cylindrical fitting portion 7 and are provided to extend in a front-rear direction of the inner housing 4 in parallel to each other.

The terminal holding member 12 includes a front tubular portion 12b provided in a substantially round tubular shape on the front side with a step portion 12a interposed therebetween, and a rear tubular portion 12c provided in a substantially square tubular shape on the rear side with the step portion 12a interposed therebetween.

The coupling portion 13 connects the rear tubular portions 12c of the terminal holding members 12 adjacent to each other. The coupling portion 13 has an insulating wall 13a extending in a flat plate shape rearward relative to the rear tubular portion 12c.

As illustrated in FIGS. 7 and 8, the connector housing 2 has a stopper 14 that is brought into contact with part of the terminal holding members 12 fitted into the cylindrical fitting portion 7. In the present embodiment, the stopper 14 is constituted by a pair of rib walls 14a protruding inward from an inner peripheral surface on both sides along a lateral direction of the cylindrical fitting portion 7.

As illustrated in FIGS. 3, 4, and 8, the inner housing 4 is accommodated in the space K inside the connector housing 2 by fitting the front tubular portions 12b of the terminal holding members 12 inside the cylindrical fitting portion 7 and bringing the step portion 12a of each of the terminal holding members 12 into contact with each of the rib wall 14a (stopper 14).

The stopper 14 is not necessarily limited to the constitution of the rib wall 14a described above. That is, the stopper 14 may be configured to be brought into contact with a part of the terminal holding members 12 fitted into the cylindrical fitting portion 7, and the stopper 14 and the part of the terminal holding members 12 brought into contact with the stopper 14 may have constitutions different from the above constitution.

As illustrated in FIGS. 2 to 4, a second attaching and detaching mechanism 15 for attaching the inner housing 4 to the connector housing 2 is provided between the cylindrical fitting portion 7 and each of the terminal holding members 12.

The second attaching and detaching mechanism 15 includes a second locking portion 16 provided on a side one of the cylindrical fitting portion 7 and the terminal holding members 12 (in the present embodiment, the cylindrical fitting portion 7), and a second locked portion 17 provided on the other side (in the present embodiment, each of the terminal holding members 12).

In the present embodiment, the second locking portion 16 includes a plurality of locking claws 16a protruding from an inner peripheral surface of the cylindrical fitting portion 7. The plurality of locking claws 16a are provided side by side at predetermined intervals on the inner peripheral surface of the cylindrical fitting portion 7 corresponding to the plurality of cylindrical fitting portions 7, respectively. In the present embodiment, a total of four locking claws 16a are arranged; two on each of the inner peripheral surfaces on both sides along the longitudinal direction of the cylindrical fitting portion 7 among the inner peripheral surface of the cylindrical fitting portion 7.

On the other hand, the second locked portion 17 includes a plurality of locking holes 17b provided in each of the plurality of hook pieces 17a protruding forward from the outer peripheral surface of each of the terminal holding members 12. The plurality of hook pieces 17a are provided at positions facing the plurality of locking claws 16a, respectively. In the present embodiment, four of the hook pieces 17a and the locking holes 17b are arranged on the outer peripheral surface on both sides along the longitudinal direction of the cylindrical fitting portion 7 among the outer peripheral surfaces of the terminal holding members 12.

Each of the hook pieces 17a is provided to protrude from the outer peripheral surface of the rear tubular portion 12c toward a side of the front tubular portion 12b relative to the step portion 12a. Each of the locking holes 17b is provided to open on a side of the front tubular portion 12b relative to the step portion 12a of each of the hook pieces 17a.

In the second attaching and detaching mechanism 15, each of the locking claws 16a is locked to each of the locking holes 17b of the hook pieces 17a in a state where the plurality of terminal holding members 12 are fitted into the cylindrical fitting portion 7. With this constitution, the connector 1 of the present embodiment allows attachment of the inner housing 4 accommodated in the space K inside the connector housing 2 to the connector housing 2 via the second attaching and detaching mechanism 15.

The above second attaching and detaching mechanism 15 is not necessarily limited to the constitution in which, described above, the locking claws 16a are locked to the locking holes 17b of the hook pieces 17a. That is, the second attaching and detaching mechanism 15 only needs to have a constitution in which the second locking portion 16 is locked to the second locked portion 17, and the second locking portion 16 and the second locked portion 17 may have a constitution different from the above constitution. Furthermore, the arrangement and the number of the second locking portions 16 and the second locked portions 17 can also be appropriately changed.

In addition, the above second attaching and detaching mechanism 15 is not necessarily limited to the constitution in which, described above, the second locking portion 16 provided on the side of the cylindrical fitting portion 7 is locked to the second locked portion 17 provided on a side of each of the terminal holding members 12. That is, the second attaching and detaching mechanism 15 can be configured to lock the second locking portion 16 provided on the side of each of the terminal holding members 12 to the second locked portion 17 provided on the side of the cylindrical fitting portion 7.

As illustrated in FIGS. 2 to 4 and FIGS. 6 to 8, the connector terminals 5 are made of a metal conductor such as brass, for example, and are provided in an elongated plate shape corresponding to the terminal holding members 12. The connector terminals 5 are held by the terminal holding members 12 in a state of being inserted into the terminal holding members 12 along an inner peripheral surface of the terminal holding members 12 on a side opposite to the coupling portion 13.

On the rear end side of each of the connector terminals 5, a terminal bonding portion 5a protruding rearward relative to the rear tubular portion 12c of each of the terminal holding members 12 is provided so as to face the insulating wall 13a.

As illustrated in FIGS. 2 to 4, the wire cords 6 have a constitution in which a wire such as copper is covered with an insulating resin. One end of each of the wire cords 6 is joined to each of the terminal bonding portions 5a of the pair of connector terminals 5. The wire cords 6 are accommodated in the space K inside the connector housing 2 along the longitudinal direction of the connector housing 2. In addition, the other end of each of the wire cords 6 is bent at a substantially right angle at a position facing the cord lead-out portion 8 and then extended outside of the connector housing 2 through each of the hole portions 8a of the cord lead-out portion 8.

In addition, a partition wall 18 that partitions the wire cords 6 adjacent to each other is provided inside the connector housing 2. The partition wall 18 is provided to protrude rearward from the back side of the front wall 2a while extending along the longitudinal direction of the connector housing 2.

In the present embodiment, the above-described cord lead-out portion 8 is provided on the front side of the connector housing 2, but the cord lead-out portion 8 may be provided on the peripheral wall 2b located on the other side in the longitudinal direction of the connector housing 2.

Meanwhile, in the connector 1 of the present embodiment, as illustrated in FIGS. 3 to 8, a guide portion 19 that is located inside the connector housing 2 and restricts positions of the terminal holding members 12 with respect to the cylindrical fitting portion 7 in the one direction in which the terminal holding members 12 are fitted into the cylindrical fitting portion 7 is provided.

The guide portion 19 has a pair of guide walls 19a at positions where the coupling portion 13 is sandwiched between the terminal holding members 12 adjacent to each other. The pair of guide walls 19a are located on both sides with the coupling portion 13 interposed therebetween and are provided in parallel to each other so as to protrude rearward from the back side of the front wall 2a.

On the other hand, the inner housing 4 has a pair of guide grooves 20 between the terminal holding members 12 adjacent to each other. The pair of guide grooves 20 are located on both sides with the coupling portion 13 interposed therebetween and are provided to extend in the front-rear direction of the terminal holding members 12 in parallel to each other.

In the connector 1 of the present embodiment, as illustrated in FIGS. 4 and 6 to 8, by causing the pair of guide walls 19a to be engaged with the pair of guide grooves 20, the pair of guide walls 19a regulates the positions of the respective terminal holding members 12 with respect to the cylindrical fitting portion 7 in the one direction in which the terminal holding members 12 are fitted into the cylindrical fitting portion 7.

In addition, as illustrated in FIGS. 7 and 8, the connector 1 of the present embodiment can slidably guide each of the terminal holding members 12 to the inside of the cylindrical fitting portion 7 in a state where the pair of guide walls 19a are engaged with the pair of guide grooves 20.

With this constitution, in the connector 1 of the present embodiment, by facilitating the assembly work at the time of assembling of the inner housing 4 to the connector housing 2 described above and reducing the burden of the assembly work, it is possible to improve efficiency of the assembly work.

In addition, as illustrated in FIG. 4, the connector 1 of the present embodiment can electrically insulate between the terminal holding members 12 that are coupled via the coupling portion 13 in a state where the pair of guide walls 19a are engaged with the pair of guide grooves 20.

Moreover, in the connector 1 of the present embodiment, as illustrated in FIG. 8, in a state where a part of the terminal holding members 12 is in contact with the stopper 14 described above, joint portions (terminal bonding portions 5a) between the connector terminals 5 and the wire cords 6 are at positions facing the insulating wall 13a. Furthermore, the pair of guide walls 19a are positioned rearward relative to the insulating wall 13a.

With this constitution, in the connector 1 of the present embodiment, it is possible to reliably insulate the joint portions between the connector terminals 5 and the wire cords 6 described above, and between the terminal holding members 12 including the connector terminals 5, and therefore occurrence of a short circuit between the components can be prevented.

In the above embodiment, the connector 1 including the two connector terminals 5 is exemplified, but the same constitution as that of the connector 1 can be applied to a connector including a plurality of connector terminals such as three or four.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description and is only limited by the scope of the appended claims.

### REFERENCE SIGNS LIST

1 connector

2 connector housing

3 connector cover

4 inner housing

5 connector terminal

5a terminal bonding portion

6 wire cord

7 cylindrical fitting portion

8 cord lead-out portion

8a hole portion

9 first attaching and detaching mechanism

10 first locking portion

11 first locked portion

12 terminal holding member

13 coupling portion

13a insulating wall

14 stopper

15 second attaching and detaching mechanism

16 second locking portion

17 second locked portion

18 partition wall

19 guide portion

19a guide wall

20 guide groove

What is claimed is:

1. A connector comprising:
a connector housing including a cylindrical fitting portion protruding in a tubular shape in a direction in which the cylindrical fitting portion is fitted to a mating connector;
an inner housing including a plurality of terminal holding members fitted into the cylindrical fitting portion in a state of being accommodated inside the connector housing;
a connector terminal held by the terminal holding members; and
a wire cord having one end side joined to the connector terminal, and the other end side extended outside of the connector housing through a hole portion provided in the connector housing,
wherein the connector housing includes a guide portion that regulates positions of the terminal holding members with respect to the cylindrical fitting portion in a one direction in which the terminal holding members are fitted into the cylindrical fitting portion.

2. The connector according to claim 1, wherein
the inner housing includes a coupling portion that connects the terminal holding members adjacent to each other, and
the guide portion includes a pair of guide walls at positions sandwiching the coupling portion between the terminal holding members.

3. The connector according to claim 2, wherein the inner housing includes, between the terminal holding members, a pair of guide grooves with which the pair of guide walls are engaged.

4. The connector according to claim 2, wherein
the coupling portion includes an insulating wall extending in a direction opposite to the one direction from between the terminal holding members,
the connector housing includes a stopper that is brought into contact with a part of the terminal holding members fitted into the cylindrical fitting portion, and
in a state where the stopper is brought into contact with the part of the terminal holding members, a joint portion between the connector terminal and the wire cord is at a position facing the insulating wall.

5. The connector according to claim 1, further comprising a connector cover that closes an opening of the connector housing on a side opposite to a side where the cylindrical fitting portion is provided.
